(19) United States
(12) Patent Application Publication
(10) Pub. No.: US 2025/0256521 A1
(43) Pub. Date: Aug. 14, 2025

(54) Substrate loader for simultaneously loading multiple substrates on a transport belt

(71) Applicant: CANON KABUSHIKI KAISHA, Tokyo (JP)

(72) Inventor: Marcus H.G.W. Hees, Echt (NL)

(21) Appl. No.: 19/050,892

(22) Filed: Feb. 11, 2025

(30) Foreign Application Priority Data
Feb. 12, 2024 (EP) 24157109.0

(51) Int. Cl. B41J 13/22; B41J 3/28; B41J 11/00; B41J 13/00; B41J 13/28; B41J 15/04

(52) U.S. Cl. CPC B41J 13/226; B41J 3/28; B41J 11/0085; B41J 13/0072; B41J 13/28; B41J 15/04

(57) ABSTRACT

A method for efficiently multiple loading substrates simultaneously onto an endless transport belt of a printer, including steps of engaging each substrate by an array of grippers, each gripper being rotatably mounted on a support beam; pivoting and/or rotating the support beam with the grippers gripping the substrates, so that the substrates are positioned on the transport belt over at least one suction chamber; driving the transport belt to move the substrates, while a negative pressure is applied to the substrates via the at least one suction chamber, so that trailing portions of each of the substrates are pulled onto the belt.

### CROSS-REFERENCE TO RELATED APPLICATIONS

This application claims the benefit of European Patent Application No. 24157109.0 filed on Feb. 12, 2024, which is incorporated by reference herein in its entirety.

### BACKGROUND OF THE DISCLOSURE

### Field of the Disclosure

The disclosure relates to a method for loading substrates onto an endless transport belt of a printer, to a printer with such a transport belt, and to a substrate loader for use in such a printer.

### Description of Background Art

Hybrid printers generally have two print modes, one substrate print mode for printing on individual substrates, preferably on multiple, parallel substrates, and a roll print mode for printing on web print media provided in roll form. Substrates are preferably provided in multiple, different stacks positioned near the transport belt. The substrates are generally loaded one by one by an operator or a substrate loader onto the belt.

### SUMMARY OF THE DISCLOSURE

It is an aspect of the disclosure to provide an improved method and/or a printer for loading substrates onto the transport belt, preferably in a time and/or costs efficient manner.

In accordance with the present disclosure, a method for loading substrates onto an endless transport belt of a printer, a printer for parallel printing on multiple substrates, and a substrate loader for use in such a printer are provided.

The method comprises the steps of engaging each substrate by an array of grippers, each gripper being rotatably mounted on a support structure pivotable around a pivot point; moving the support structure with the grippers gripping the substrates with respect to the pivot point, so that the substrates are positioned on the transport belt over at least one suction chamber; and driving the transport belt to move the substrates, while a negative pressure is applied to the substrates via the at least one suction chamber, so that trailing portions of each of the substrates are pulled onto the transport belt.

The different grippers allow multiple, different substrates to be gripped simultaneously. The grippers grip the substrates, preferably at a respective leading portion, between a center of a substrate and its leading edge, more preferably adjacent or at the leading edge. By moving the support structure, all gripped substrates are transported simultaneously to the transport belt. The independent rotatability of the different grippers allows the substrate loader to compensate for the differences between different types of substrates, for example differences in size, material, rigidity, etc. Each substrate type exerts a different tension on its respective gripper under the influence of gravity. The grippers on each substrate rotate accordingly which prevents damage to the substrate, such as folds or wrinkles. The grippers position the substrates on the transport belt over the at least one suction chamber. This allows the portions of the substrates to be held on the transport belt by means of a negative pressure in the at least one suction chamber. The grippers can then release the substrates, while these remain held on the transport belt. Consequently, the transport belt is driven forward thereby pulling the trailing portions of the substrates onto the transport belt, so that the substrates become entirely positioned on the transport belt. The substrates can then be transported further for printing. By using the transport belt to pull the trailing portions of the substrates onto the transport belt, the construction of the moving support structure can be kept relatively compact and/or inexpensive. Thus, multiple substrates can be loaded in a simple and efficient manner. Thereby the aspect of the present disclosure has been achieved.

More specific optional features of the disclosure are indicated in the dependent claims.

In an embodiment, the support structure includes a support beam, with respect to which the grippers are movable and/or rotatable. Preferably, a support beam extending over the width of the transport belt is provided to hold the grippers, so that substrates can be deposited at any lateral position on the belt. Preferably, the support beam is rotated, pivoted, and/or shifted to transfer the leading portions of the substrates onto the belt.

In an embodiment, the substrates are stacked in parallel stacks on different stack holders. Multiple stacks are positioned besides one another upstream of the transport belt. The stacks are preferably aligned along the transport direction, so that their leading edges have a substantially corresponding or the same position.

In an embodiment, the method further includes the step of deforming the grippers to compensate for height differences between the parallel stacks on the different stack holders. The top surface of each stack may be at a different height, due to a different loading of substrates and/or differences in substrate types. To allow multiple substrates to be reliably picked up, the grippers are deformable. In an undeformed state, the grippers would extend through the surface of the lowest substrate. By contact with the substrates the grippers are compressed. Each gripper may be compressed to a different degree proportional to the respective stack height. Thus, all grippers can reliably engage a substrate despite height differences.

In an embodiment, leading portions of the substrates move synchronously along a substantially curved and/or semi-circular path when held by the grippers. The path is at least partially non-linear and includes one or more curves due to the rotation of the drippers under the influence of gravity. The grippers preferably pivot or rotate along an arch between the stacks and the transport belt. During the first portion and/or half of the arch, the leading portions are moved upwards and after that descend onto the transport belt over the one or more suction chambers. Since the grippers rotate under the influence of gravity on the respective substrates, the trajectory per gripper or substrate may vary, though the curvatures of the arches are roughly similar. The movement of the leading portions is e.g. defined by a two (or more) rod mechanism, resulting in the pivoting and/or rotating path followed by the grippers.

In an embodiment, at least during a first portion of their movement along the substantially curved and/or semi-circular path the trailing edges of the substrates are supported on the parallel stacks on the different stack holders. On a first portion, preferably on at least the first half of the path, the trailing portions of one or more substrates remain supported on the respective stacks. This reduces the respective load on the grippers.

In an embodiment, the step of engaging includes applying suction via the grippers to the substrates. Each gripper includes an open-ended channel, which is positioned on the substrate in a sealing manner. By applying suction, i.e. a negative pressure to the channel, the substrate is held against the gripper. Since the gripper is deformable, this allows the substrate to be gripped without damaging or deforming the substrate.

In an embodiment, each gripper applies suction at at least two different points on the leading portions of the substrates spaced apart from one another in a transport direction of the belt. Each gripper preferably has two suction cups, which engage the substrate at different positions in the transport direction. Gripping at two point provides a secure holding and aids in controlling the rotation of each gripper, resulting in a smooth and controlled motion of the leading portions of the substrates.

The present disclosure further relates to a printer. The printer includes a transport belt supported on support rollers and suspended over at least one suction chamber, the printer can parallel print on multiple substrates positioned together on the transport belt; a substrate loader for simultaneously transferring substrates between a stack of substrates and the transport belt, which substrate loader includes an array of independently rotatably grippers pivotable around a pivot point, wherein the grippers are mounted on a displacement mechanism, such that the grippers, while holding the substrates, move along an at least partially curved path from the stack to an area of the transport belt over the at least one suction chamber, so that trailing portions of the substrates extend over and/or upstream of the support rollers in the transport direction, wherein the transport belt is configured to draw the trailing portions of the substrates entirely onto the transport belt when a negative pressure is applied to the at least one suction chamber.

The printer includes a vacuum transport belt extending over one or more suction chambers, so that substrates can be held onto the belt by applying negative to the one or more suction chambers. Upstream of the transport belt, multiple stacks of substrates can be positioned on different stack holders. The substrate loader is preferably positioned between the transport belt and the stack holders. The displacement mechanism is positioned, such that in a pick-up position, the grippers are positioned on the leading portions of the top sheets of the substrates. Therein, a portion of each gripper can extend besides or even underneath a substrate. Suitable grippers are e.g. suction cups, clamps, pinch grippers, or electrostatic attractors. The displacement mechanism moves the grippers through an arch into a release position, wherein the leading portions of the substrates are overlapping the one or more suction chambers. The displacement mechanism deposits the leading portions preferably over an upstream area or side of the one or more suction chambers. Multiple grippers are provided in an array extending in the lateral direction of the transport belt, so that multiple substrates can be gripped at once and moved by a single pivoting action. The substrates are positioned on the transport belt with trailing portions extending at least over the upstream support roller for the transport belt, and possibly even further upstream. The substrates may be positioned only partially on the transport belt. By applying sufficient negative pressure in the one or more suction chambers, the leading portions are securely held onto the transport belt. By driving the transport belt forward, the substrates are entirely drawn onto the transport belt. Thus, multiple substrates are loaded by a simple yet efficient substrate loader mechanism.

In an embodiment, each gripper includes a compressible substrate engager. The grippers are deformable, specifically compressible to reliably engage substrates at different height levels. Preferably, a substrate engaging portion of each gripper is compressible, so that deformation of the substrates by contact with the engager is prevented. It will be appreciated that a compression length of the compressible substrate engagers will define the maximum height difference. This provides a limited range of e.g. up to 10, 20, or even 30 centimeters for height differences between stacks which can be overcome. Outside said working range the stack heights may be adjusted by moving stacks up and or down and/or adding or removing substrates to certain stacks.

In an embodiment, each compressible substrate engager includes at least two deformable suction cups spaced apart from one another in the transport direction. The respective suction cups are positioned on a substrate at different positions in the transport direction. In absence of a substrate, the suction cups are mounted to opposing sides of a rotation point of a respective gripper, when viewed in the lateral or vertical direction. By gripping the substrate at two different point, a leveling force is present on the leading edge, preventing excessive rotation. This results in a smooth and continuous motion of the substrate and the gripper.

In another embodiment, the displacement mechanism includes a support structure rotatably holding the grippers. The path of the leading portions is preferably different from that of the support structure due to rotation of the grippers. The support structure may for example rotate, pivot, slide, or shift towards the belt. In one example, the displacement mechanism includes one (or more) rod mechanism that connects the grippers to a during use stationary pivot point. In another example, the support structure may move linearly, e.g. in the during use vertical and/or horizontal direction. In all examples, the path of the leading portion of each substrate curves differently from that of the support structure. In case of a linearly moving support structure, the path of the leading portions may include linear segments, but also includes curving segments, for example when lowering and/or raising the leading portion.

In an embodiment, the grippers are rotatably mounted on a support structure, wherein a path of the support structure is defined by the displacement mechanism, and the displacement mechanism with the rotatable grippers define a path for the gripped leading portions of the substrates, which path is at least partially curved and different from the path of the support structure. The path of the support structure is fixed by the displacement mechanism and preferably constant over time. The path of the leading portions of the substrates is in part determined by the influence of gravity exerted on the grippers by the substrate. This causes the path of the leading portions to be non-parallel to that of the support structure, at least for certain segments of the paths. The rotation of the grippers further causes the path of the leading portions to locally curve away from that of the support structure by the substrate pulling on the grippers. Even when the path of the support structure is linear or includes sharp turns, the rotation of the grippers ensures a smooth path for leading portion, avoiding folding of and/or damage to the substrate.

In an embodiment, the displacement mechanism includes at least one arm pivotable around a during loading stationary pivot point, wherein the arm and the pivot point are dimensioned and/or positioned with respect to stack holders for supporting the stacks, such that the substrates are loaded only partially onto the transport belt with their leading portions covering the at least one suction chamber and their trailing portions extending upstream of the at least one suction chamber in the transport direction. The rotatable gripper and the arm form an at least two rod mechanism, which defines the curved path of the grippers. The rod mechanism is such that an effective length of its arm with respect to the pivot point is greater than a diameter of the upstream support roller of the transport belt. The effective length is further such that each gripper is deposited on a substrate on the stack side between its center and its leading edge. It will be appreciated that the pivot mechanism can include multiple similar arms at different lateral positions, for example at the outer ends of the support beam. Multiple arms allow the curved path to be less steep, so that the substrate's leading portion need not be raised so high as compared to using a single arm. Alternatively, the displacement mechanism can include sliders or shifters that move the support structure along a linear path for at least a segment of its total trajectory.

In an embodiment, during loading, the pivot point is positioned between the stack holders and the transport belt in the transport direction. The pivot point is preferably stationary during loading.

In an embodiment, the printer further includes a contact aligner positionable on and/or over the transport belt, wherein the contact aligner is aligned with respect to the transport direction, such that by driving an edge of a substrate against it, the substrate is correspondingly aligned. The contact aligner may for example be an alignment plate or stopper aligned in e.g. the transport or lateral direction. By moving a substrate against the contact aligner while allowing it to slip over the transport belt, the substrate is aligned in a desired orientation, for example with its leading edge parallel to an array of printheads or a scanning direction of such printheads. In one example, the negative pressure in the one or more suction chambers is lowered or de-activated, so that an operator can press the substrate against the contact aligner. Multiple contact aligners may be provided at different lateral positions.

In an embodiment, the printer is a hybrid printer, further including an input roller for supplying print media in web form. In a first print mode, the printer is configured for transporting individual substrates, preferably in parallel lanes, and printing thereon. In a second print mode, a web extends between an input roller and an output roller, so that roll printing can be performed. Preferably in both print modes, the transport is controlled by the transport belt.

The disclosure further relates to a substrate loader for transferring substrates between a stack of substrates and a transport belt of a printer as described above, which substrate loader includes an array of independently rotatably grippers, which grippers are mounted on a pivot mechanism, such that the grippers while holding the substrates move along a curved path from the stack to an area of the transport belt over the suction box, so that a trailing portion of the substrates extends over and/or upstream of the upstream support roller in the transport direction, wherein the transport belt is configured to draw the trailing portions of the substrates entirely onto the transport belt when a negative pressure is applied to the at least one suction chamber. The substrate loader may be configured as in any of the above-described embodiments.

Further scope of applicability of the present disclosure will become apparent from the detailed description given hereinafter. However, it should be understood that the detailed description and specific examples, while indicating embodiments of the present disclosure, are given by way of illustration only, since various changes and modifications within the spirit and scope of the present disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure, and wherein:

FIG. 1 is a schematic, perspective view of a hybrid printer in a first print mode;

FIG. 2 is a schematic, perspective view of the hybrid printer in FIG. 1 in a second print mode;

FIGS. 3 to 6 are schematic, cross-sectional side views of different steps of loading multiple substrates for the printer in FIG. 1 in its first print mode;

FIG. 7 is a schematic, top down side view of the step in FIG. 4;

FIGS. 8 and 9 are schematic side views of a first embodiment of a gripper used in FIGS. 3 to 7 in, respectively, an uncompressed state and a compressed state;

FIG. 10 is a schematic side view of a second embodiment of a gripper;

FIG. 11 is a schematic, cross-sectional side view of another embodiment of the printer in FIG. 1 in its first print mode; and

FIG. 12 is a schematic, cross-sectional side view of a further embodiment of the printer in FIG. 1 in its first print mode.

### DETAILED DESCRIPTION OF THE EMBODIMENTS

The present disclosure will now be described with reference to the accompanying drawings, wherein the same reference numerals have been used to identify the same or similar elements throughout the several views.

### Printing System

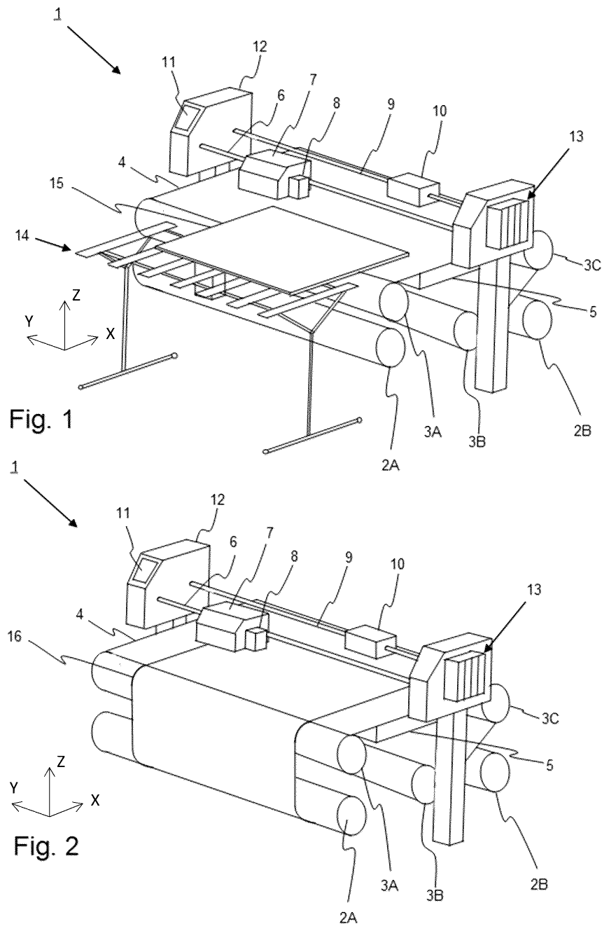

FIG. 1 shows a wide format inkjet printer 1. The wide-format printer 1 includes an inkjet printing assembly 7 for printing on a print medium 15. The print medium 15 in FIG. 1 is a relatively rigid substrate, such as a panel. The print medium 15 is supplied from a media input unit 14, which can be configured for storing a plurality of such print media 15 and supplying these to the printer 1. The printer 1 includes transport means for receiving and transporting the print medium 15 along the inkjet printing assembly 7. In FIG. 1, the transport means includes an endless transport belt 4 supported on a plurality of support rollers 3A, 3B, 3C. At least one of the support rollers 3A, 3B, 3C is provided with driving means for moving the belt 4. Additionally, one or more one of the support rollers 3A, 3B, 3C can be configured to be moved and/or tilted to adjust and control the lateral position of the belt 4. The inkjet printing assembly 7 may be provided with a sensor 8, such as a CCD camera, to determine the relative position of belt 4 and/or the print medium 15. Data from said sensor 8 may be applied to control the position of the belt 4 and/or the print medium 15. The belt 4 is further provided with through-holes and a suction chamber 5 in connection with a suction source (not shown), such that a negative pressure may be applied to the print medium 15 via the through-holes in the belt 4. The negative pressure adheres the print medium 15 flatly to the belt 4 and prevents displacement of the print medium 15 with respect to the belt 4. Due to this holding, the belt 4 is able to transport the print medium 15. It will be appreciated that other suitable transport means, such as rollers, steppers, etc, may alternatively be applied. The print medium 15 may be transported stepwise and/or in continuous movement.

The inkjet printing assembly 7 is configured to translate along a first guide beam 6 in a scanning direction. The scanning direction is perpendicular to the direction in which the print medium is transported by the belt 4. The inkjet printing assembly 7 holds a plurality of print heads (not shown), which are configured to jet a plurality of different marking materials (different colors of ink, primers, coatings, etc.) on the print medium 15. Each marking material for use in the printing assembly 7 is stored in one of a plurality of containers arranged in fluid connection with the respective print heads for supplying marking material to said print heads to print an image on the print medium 15.

The ejection of the marking material from the print heads is performed in accordance with data provided in the respective print job. The timing by which the droplets of marking material are released from the print heads determines their position on the print medium 15. The timing may be adjusted based on the position of the inkjet printing assembly 7 along the first guide beam 6. The above-mentioned sensor 8 may therein be applied to determine the relative position and/or velocity of the inkjet printing assembly 7 with respect to the print medium 15. Based upon data from the sensor 8, the release timing of the marking material may be adjusted.

Upon ejection of the marking material, some marking material may be spilled and stay on a nozzle surface of the print heads. The marking material present on the nozzle surface may negatively influence the ejection of droplets and the placement of these droplets on the print medium 15. Therefore, it may be advantageous to remove excess of marking material from the nozzle surface. The excess of marking material may be removed, for example, by wiping with a wiper and/or by application of a suitable anti-wetting property of the surface, e.g. provided by a coating.

The marking materials may require treatment to properly fixate them on the print medium. Thereto, a fixation unit 10 is provided downstream of the inkjet printing assembly 7. The fixation unit 10 can emit heat and/or radiation to facilitate the marking material fixation process. In the example of FIG. 1, the fixation unit 10 is a radiation emitter that emits light of certain frequencies, which interacts with the marking materials, for example UV light in case of UV-curable inks. The fixation unit 10 in FIG. 1 is translatable along a second guide beam 9. Other fixation units 10, such as page-wide curing or drying stations may also be applied. Further, the inkjet printing assembly 7 may be provided with a further fixation unit on the same carriage, which holds the print heads. This further fixation unit can be used to (partially) cure and/or harden the marking materials, independent of or interaction with the fixation unit 10.

After printing, and optionally fixation, the print medium 15 is transported to a receiving unit (not shown). The receiving unit may include a take-up roller for winding up the print medium 15, a receiving tray for supporting sheets of print medium 15, or a rigid media handler, similar to the media input unit 14. Optionally, the receiving unit may include processing means for processing the medium after printing, e.g. a post-treatment device such as a coater, a folder, a cutter, or a puncher.

The wide-format printer 1 furthermore includes a user interface 11 for receiving print jobs and optionally for manipulating print jobs. The local user interface unit 11 is integrated to the print engine and may include a display unit and a control panel. Alternatively, the control panel may be integrated in the display unit, for example in the form of a touch-screen control panel. The local user interface unit 11 is connected to a control unit 12 connected to the printer 1. The control unit 12, for example a computer, includes a processor adapted to issue commands to the printer 1, for example for controlling the print process. The printer 1 may optionally be connected to a network. The connection to the network can be via cable or wireless. The printer 1 may receive printing jobs via the network. Further, optionally, the control unit 12 of the printer 1 may be provided with an input port, such as a USB port, so printing jobs may be sent to the printer 1 via this input port.

### Hybrid Printing System

The printer 1 in FIG. 1 is a so-called hybrid printer, capable of handling both flexible media and rigid substrates. In FIG. 1, the printer 1 operates in a first print mode, wherein the printer 1 is configured for transporting rigid substrates, such as the print medium 15. Such rigid print media 15 may be panels for doors, walls, etc, corrugated media, plates formed of plastic or metal, etc. To handle these rigid print media 15, the printer 1 in FIG. 1 is configured with a substantially linear transport path: from the media input device 14, the print medium 15 moves forward along the inkjet printing assembly 7 at a substantially constant height. The media input unit 14 and the receiving unit are positioned at the level of the medium support surface of the belt 4. In FIG. 2, a flexible web medium 16 is supplied to the printer 1, which web medium 16 may be composed of e.g. paper, label stock, coated paper, plastic or textile. The web medium 16 is supplied from the input roller 2A and extends across the belt 4 to the take-up roller 2B, where the web medium 16 is re-wound. The printer 1 is configured to swiftly and efficiently switch between print modes.

### Substrate Loader

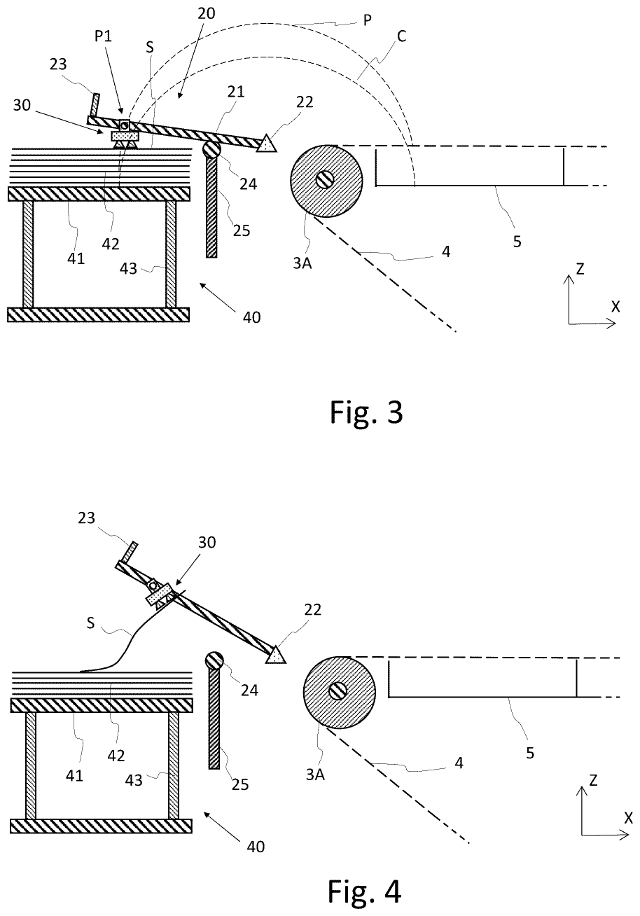

FIG. 3 illustrates a side view of a substrate loader 20 positioned between a stack holder 40 and a transport belt 4. The stack holder 40 includes a liftable stack support 41 configured to support a stack 42 of substrates. A lift 43 is provided to raise the stack support 41 with respect to the top surface of the transport belt 4 in the vertical direction Z. The lift 43 may for example be a motorized spindle, chain, cable, or rack and pinion system connected to a support plate that forms the stack support 41. The lift 43 is preferably controlled to maintain the top of the stack 42 at substantially the same height level as the number of substrates in the stack 42 changes.

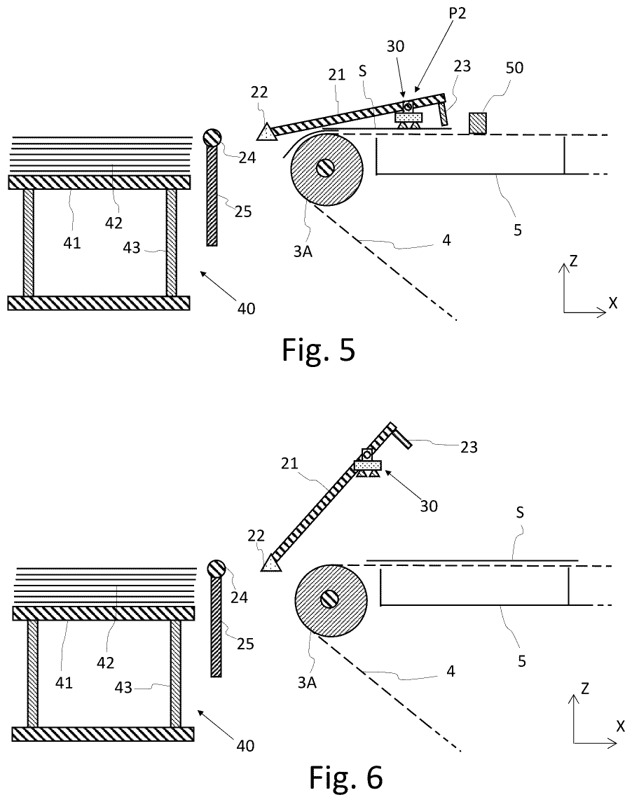

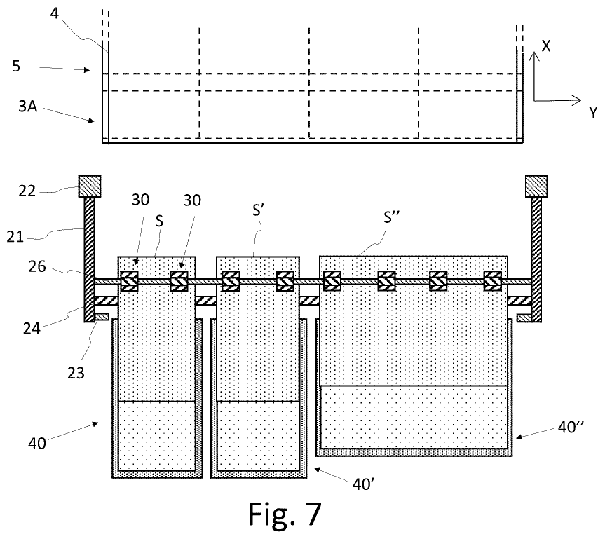

The substrate loader 20 includes a displacement mechanism with a pivotable arm 21 arranged to pivot or rotate around a pivot point 22. As illustrated in FIG. 7, the substrate loader 20 includes two such arms 21 on both lateral sides, which arms 21 between them hold the support structure including the support beam 26. The pivot points 22 for the arms 21 have similar positions in the transport direction X and the vertical direction Z, but are spaced apart in the lateral direction Y. The support beam 26 is attached to the arms 21 at or near the end of each arm 21, which end is opposite the end at the pivot point 22. As such, the support beam 26 is able to be moved along a curved path C between a pick-up position (P1 as shown in FIG. 3) and a release position (P2 as shown in FIG. 5).

The pick-up position P1 is positioned on an upstream side of the pivot point 24 in the transport direction X. The pick-up position P1 is at the top of the stack 42 over the stack support 41. Though the height of the stack 42 is adjusted constantly by the lift 43, the pick-up position P1 may vary in position within a limited range due to removal of substrates from the stack 42. The release position P2 is positioned downstream of the pivot point 24 in the transport direction X. The release position P2 is positioned at the upstream side of the transport belt 4 over the suction chamber 5. The release position P2 is downstream of the upstream support roller 3A, preferably near or adjacent said support roller 3A. The pick-up and release positions P1, P2 preferably have similar height positions in the vertical direction Z, so that the curved path C includes a substantially semi-circular trajectory. The curved path C may be delimited on the upstream by a stopper 24, for example in the form of a contact block. The stopper 24 defines an end point for the arm 21 when it moves opposite the transport direction X. Preferably, the stopper 24 is provided with a damper, such as a rubber block or layer to absorb the impact of the arm 21. The stopper 24 is mounted on a support rod 25 at the appropriate height. An adjusting mechanism may be provided to adjust the height of the stopper 24. The stopper 24 prevents deformation or damage of the substrates 24 by reducing or avoiding impact. On the downstream side, the curved path P is delimited by the belt 4 and/or the suction box 5. The arms 21 and/or the support beam 26 are provided with a stopper protrusion 23 that extends perpendicular to the arms 21. The downstream end position of the curved path C is defined where the free end of the stopper protrusion 23 contacts the belt 4 and/or the suction chamber 5. It will be appreciated that a frame holding the suction chamber 5 may be provided with a separate contact region, such as a stopper plate or block outside of the suction chamber 5. In addition, it will be appreciated that the stopper protrusion 23 and the stopper 24 may be exchanged, so that these are present on opposite sides of the pivot point 22, as compared to FIG. 3.

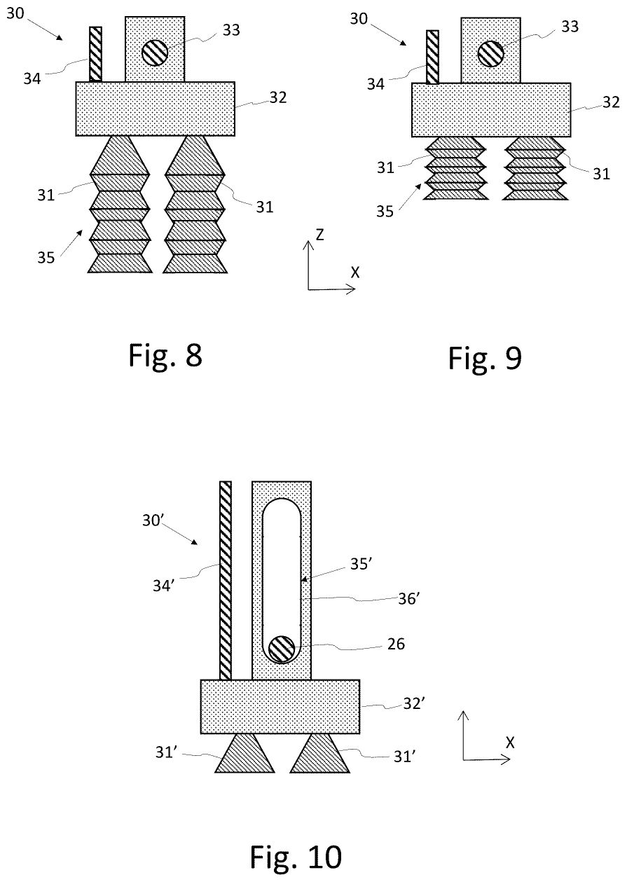

The support beam 26 holds a plurality of grippers 30 for engaging and releasably holding an individual substrate S. One embodiment of the grippers 30 is illustrated in detail in FIGS. 8 and 9. The grippers 30 are mounted freely rotatable on the support beam 26, so that their orientation or angle with respect to the arms 21 can be adjusted, for example under the influence of gravity and/or a pulling force from an engaged substrate S. Each gripper 30 includes a main body 32. A channel structure (not shown) has been provided in the main body 32, which connects a suction line 34 to the suction cups 31. The suction cups 31 are arranged to be deformable, such that their length is adjustable. In FIG. 9 as compared to FIG. 8, the suction cups 31 have been compressed in their length direction, which in said Figures is parallel to the vertical direction Z. The suction 31 cups may be deformable based on their material or structure, for example by forming them of an elastic rubber or plastic and/or forming them with a harmonica structure. The suction cups 31 thus form a compressible substrate engager 35. The suction cups 31 are provided with a negative pressure via the suction line 34, which connects to a suction source (not shown), such as a pump or fan. Preferably, at least two suction cups 31 are provided per main body 32 at different positions in the transport direction X. The gripper 30 is able to rotate or pivot with respect to the support beam 26 and/or the arms 21 by means of the rotational bearing 33. The rotational bearing 33 in FIG. 8 is formed as a circular through-hole with a diameter greater than that of the support beam 26. Different bearings such as ball bearing may also be applied. The grippers 30 are independently rotatable with respect to one another.

### Loading Multiple Substrates

In FIG. 3, the stack 42 of substrates has been provided on the stack support 41. The lift 43 has positioned the top of the stack 42 at the operative height level. FIG. 3 illustrates the step of positioning the grippers 30 in the pick-up position P1. The stopper 24 is positioned, so that the arm 21 is above the top of the stack 42. Also, the main body 32 of the gripper 30 is prevented from coming into direct contact with the stack 42 to prevent damage to the substrates S. The compressible substrate engager 35 directly engages the top substrate S on the stack 42 and is thereby compressed and is preferably the sole component of the substrate loader 20 to directly contact the substrates S-S″. The stopper 24 defines the pick-up position P1, such that the main body 32 of the gripper 30 is above the top of the stack 42, but its distance to the top of the stack 42 is less than a length of the compressible substrate engager 35 in an uncompressed state. The compression ensures a reliable grip and appropriate suction for holding the substrate S by the gripper 30. The compression also allows for height differences between stacks, so that each stack 42 need not be at exactly the same height for each loading operation. In addition, as shown in FIG. 7, multiple grippers 30 are provided on the support beam 26 and may simultaneously load multiple substrates S-S″ from different stack holders 40-40″. The compressible substrate engagers 35 of the grippers 30 can thus compensate for height differences between the different stacks. This allows for quick loading without the need for accurately aligning the different stack heights.

The grippers 30 in FIG. 3 engage a leading portion of the substrate S near its leading edge in the transport direction X. By compressing the compressible substrate engager 35 onto the substrate S, suction is applied to the substrate S and the substrate S becomes held by the gripper 30. With reference to FIG. 7, it is noted that simultaneously multiple substrates S-S″ are loaded from different stack holders 40-40″ by means of different grippers 30. For each different substrate S-S″, the loading proceeds as discussed herein below. As explained, the compressibility of the compressible substrate engagers 35 allows the different stacks 42 of the different stack holders 40-40″ to be at different heights.

FIG. 4 illustrates the step of moving the gripper 30 along the curved path P towards the release position P2. The arm 21 is rotated around its pivot point 22 either by a drive or manually by an operator. Thereby, the gripper 30 is moved away from the top of the stack 42. The top substrate S is held by suction onto the gripper 30, so it is lifted partially from the stack 42. Since the gripper 30 holds the leading portion of the substrate S, the leading portion is lifted, while the trailing portion is still supported by the stack 42. The gripper 30 rotates freely with respect to the support beam 26 due to the substrate S pulling on it under the influence of gravity. The gripper 30 rotates to conform to the substrate S along the curved path P. The rotation is determined by the properties of the substrates S, specifically its dimensions and material. As the gripper 30 rotates freely, folding of the substrate S is avoided. Since the trailing portion of the substrate S rests on the stack 42, it is partially supported there, avoiding excessive force on the trailing portion and/or the gripper 30.

The gripper 30 with the leading portion of the substrate S moves through the curved path C until it reaches the release position P2. In the release position P2, the gripper 30 has brought only a leading portion of the substrate S onto the transport belt 4 over the suction chamber 5. A trailing portion of the substrate S extends upstream of the suction chamber 5. The trailing portion lies over the upstream support roller 3A, and may even extend upstream beyond the transport belt 4, so that it hangs of the transport belt 4. The trailing edge of a substrate S may even in certain cases still be supported on the stack 42.

FIG. 5 illustrates the step of releasing the substrate S from the gripper 30. The gripper 30 arrives at the release position P2, when the stopper protrusion 23 contacts the top surface of the suction box 5 besides the belt 4. The stopper protrusion 23 may also contact the belt 4 directly or any suitable stop surface on the frame of the printer 1. Similarly to the stopper 24, the stopper protrusion 23 when in the release position P2 ensures that only the compressible substrate engagers 35 of the grippers 30 contact the substrate S. Direct contact between the substrate S and any hard materials that may indent on the substrate S is thereby avoided.

The gripper 30 in FIG. 5 only brings the leading position of the substrate S over the suction chamber 5. A trailing portion of the substrate S extends downstream over the support roller 3A and for larger substrates S even further upstream. A negative pressure is applied to the suction box 5, which provides a holding force on the leading portion of the substrate S. The substrate S is thereby held against the belt 4. The suction from the gripper 30 is then de-activated, so that the gripper 30 releases the substrate S. Since the leading portion of the substrate S is held by the negative pressure in the suction box 5, it remains in position on the belt 4. This allows the arm 21 to be lifted away from the belt 4 in preparation of loading a new substrate S.

Optionally, the substrate S may now be aligned. This may be performed manually by an operator or an alignment mechanism may be provided. In the example of FIG. 5, the alignment mechanism includes a contact aligner 50. The contact aligner 50 provides a contact surface parallel to e.g. the transport direction X or the lateral direction Y. By pressing an edge of the substrate S against this contact surface, the substrate S can be oriented parallel to the contact surface. The negative pressure in the suction chamber 5 may be adjusted to allow the substrate S to move and/or rotate with respect to the belt 4.

FIG. 6 illustrates the step of drawing the trailing portion of the substrate S over the suction chamber 5 by driving the belt 4. The negative pressure in the suction chamber 5 is set sufficiently great to hold the leading portion of the substrate S on the belt 4 and drive it forward in the transport direction X. Thereby, the remainder of the substrate S is pulled onto the belt 4 in a suitable position for printing.

As explained above and with reference to FIG. 7, multiple grippers 30 may simultaneously grip multiple substrates S-S″ of different media types and/or sizes. Multiple substrate S-S″ can be loaded together by a single rotation of the arms 21. Since only a leading portion of each substrate S-S″ has to be initially positioned on the belt 4, different sized substrates S-S″ can be loaded together without any adjustment to the substrate loader 20. Preferably, as shown in FIG. 7, the leading edges of the different substrates S-S″ when on the stack holders 40-40″ have similar or the same position in the transport direction X. FIG. 7 further illustrates that the suction chamber 5 may be divided into separate sub-chamber to allow selectively applying negative pressure to different substrates S-S″. Also, the suction chamber 5 may be divided in sub-chambers in the transport direction X and/or the lateral direction Y, for example to form a separate sub-chamber directly downstream of the upstream support roller 3A. In this sub-chamber a relatively high negative pressure can be applied to the substrates S-S″ to hold and pull these onto the belt 4. This allows for the loading of heavier and/or larger print media.

FIG. 10 illustrates another embodiment of a gripper 30′. In FIG. 10, the compressible substrate engager 35′ is formed by longitudinal slit 26′ through which the support beam 26 extends. The support beam 26 can move freely through the slit 36′ allowing the distance between the suction cups 31′ and the support beam 26 to be adjusted.

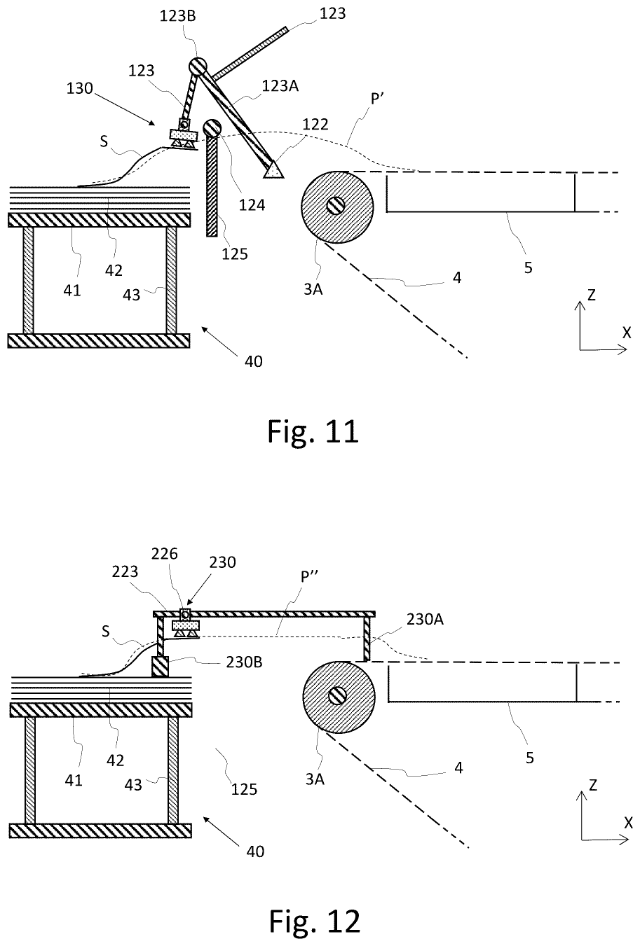

In the embodiment in FIG. 11, the displacement mechanism includes a rod mechanism having a plurality of pivotably connected arms 123, 123A. The multi-arm mechanism pivots around the stationary pivot point 122, while the one or more other pivot points 123B between the arms 123, 123A move with the grippers 130. One or more drives, such as a pulley system, may be provided to move the arms 123, 123A. By using multiple arms, the curved path P′ of the leading portions can be kept relatively low to the belt 4, which eases the load by reducing the height by which the leading portions are to be raised.

FIG. 12 illustrates an embodiment wherein the displacement mechanism includes one or more linear guides or drives, 230A, 230B, which each define a straight path for the support beam 226. Though the support beam 226 moves linearly, the path P″ of the leading portions of the substrates is different due to the grippers 230 rotating under the influence of gravity. The path of the leading portions is curved, at least when raising or lowering the leading portions.

Although specific embodiments of the disclosure are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

The present disclosure being thus described, it will be obvious that the same may be varied in many ways. Such variations are not to be regarded as a departure from the spirit and scope of the present disclosure, and all such modifications as would be obvious to one skilled in the art are intended to be included within the scope of the following claims.

1. A method for loading substrates onto an endless transport belt of a printer, the method comprising:
engaging each substrate by an array of grippers, each gripper being rotatably mounted on a support structure pivotable around a during loading stationary pivot point;
moving the support structure with the grippers gripping the substrates with respect to the pivot point, so that the substrates are positioned on the transport belt over at least one suction chamber; and
driving the transport belt to move the substrates, while a negative pressure is applied to the substrates via the at least one suction chamber, so that trailing portions of each of the substrates are pulled onto the belt.

2. The method according to claim 1, further comprising providing the substrates stacked in parallel stacks on different stack holders.

3. The method according to claim 2, further comprising the step of deforming the grippers to compensate for height differences between the parallel stacks on the different stack holders.

4. The method according to claim 3, wherein the moving the support structure with the grippers includes moving the leading portions of the substrates synchronously along a substantially curved and/or semi-circular path when held by the grippers.

5. The method according to claim 4, further comprising supporting the trailing edges of the substrates on the parallel stacks on the different stack holders at least during a first portion of the movement of the substrates along the substantially curved and/or semi-circular path.

6. The method according to claim 1, wherein the step of engaging comprises applying suction via the grippers to the substrates.

7. The method according to claim 6, wherein the applying the suction includes applying the suction by each gripper at at least two different points on leading portions of the substrates spaced apart from one another in a transport direction of the belt.

8. A printer comprising:
a transport belt supported on support rollers and suspended over at least one suction chamber, the printer can parallel print on multiple substrates positioned together on the transport belt;
a substrate loader configured to simultaneously transfer substrates between a stack of substrates and the transport belt, the substrate loader including an array of independently rotatable grippers pivotable around a pivot point,
wherein the grippers are mounted on a displacement mechanism, such that the grippers, while holding the substrates, move along an at least partially curved path from the stack to an area of the transport belt over the at least one suction chamber, so that the trailing portions of the substrates extend over and/or upstream of the support rollers in the transport direction, and
wherein the transport belt is configured to draw the trailing portions of the substrates entirely onto the transport belt when a negative pressure is applied to the at least one suction chamber.

9. The printer according to claim 8, wherein each gripper comprises a compressible substrate engager.

10. The printer according to claim 9, wherein the compressible substrate engager comprises at least two deformable suction cups spaced apart from one another in the transport direction.

11. The printer according to claim 8, wherein the displacement mechanism is dimensioned and/or positioned with respect to stack holders, such that the substrates are loaded only partially onto the transport belt with their leading portions covering the at least one suction chamber and their trailing portions extending upstream of the at least one suction chamber in the transport direction.

12. The printer according to claim 11, wherein the grippers are rotatably mounted on a support structure, wherein a path of the support structure is defined by the displacement mechanism, and the displacement mechanism with the rotatable grippers define a path for the gripped leading portions of the substrates, which path is at least partially curved and different from the path of the support structure.

13. The printer according to claim 8, further comprising a contact aligner configured to be positioned on and/or over the transport belt, wherein the contact aligner is aligned with respect to the transport direction, such that by driving an edge of a substrate against the contact aligner, the substrate is correspondingly aligned.

14. The printer according to claim 13, further comprising an input roller configured to supply print media in web form.

15. A substrate loader for transferring substrates between a stack of substrates and a transport belt of a printer, the substrate loader comprising:
an array of independently rotatably grippers mounted on a displacement mechanism, such that the grippers while holding the substrates move along an at least partially curved path from the stack to an area of the transport belt over a suction box of the printer, so that a trailing portion of the substrates extends over and/or upstream of a support roller of the printer in the transport direction,
wherein the transport belt is configured to draw the trailing portions of the substrates entirely onto the transport belt when a negative pressure is applied to the at least one suction chamber.
